(19) United States
(12) Patent Application Publication
(10) Pub. No.: US 2025/0114987 A1
(43) Pub. Date: Apr. 10, 2025

(54) INJECTION MOLDING MACHINE

(71) Applicant: SUMITOMO HEAVY INDUSTRIES, LTD., Tokyo (JP)

(72) Inventor: Shigeru TAKEUCHI, Chiba (JP)

(21) Appl. No.: 18/903,352

(22) Filed: Oct. 1, 2024

(30) Foreign Application Priority Data
Oct. 6, 2023 (JP) 2023-174294

(51) Int. Cl. B29C 45/02; B29C 45/50; B29C 45/76; B29K 67/00; B29K 105/26

(52) U.S. Cl. CPC B29C 45/02; B29C 45/50; B29C 45/7613; B29K 2067/003; B29K 2105/26

(57) ABSTRACT

An injection molding machine includes a cylinder; an injection member housed within the cylinder; and a molten resin supply device connected to the cylinder and configured to pump a molten resin from a position closer to a proximal end of the injection member than to a distal end of the injection member. In the cylinder, a pumping force applied to the molten resin by the molten resin supply device is used to move the molten resin in front of the injection member, and the molten resin is accumulated on a front side of an internal space of the cylinder. The molten resin is injected from the distal end of the cylinder by moving the injection member forward.

### CROSS-REFERENCE TO RELATED APPLICATIONS

This application is based on and claims priority to Japanese Patent Application No. 2023-174294, filed on Oct. 6, 2023, the entire contents of which are incorporated herein by reference.

### BACKGROUND

### Technical Field

The disclosure herein relates to an injection molding machine.

### Description of Related Art

An injection molding machine that fills a mold device with a molding material by using two cylinders are known. For example, there is known an injection molding machine including a first cylinder (a reservoir cylinder) and a second cylinder (an injection cylinder) to which a molten resin, which is a molding material, is supplied.

The above-described injection molding machine discharges the molten resin from the distal end of the first cylinder by moving a first injection member (a first plunger) of the first cylinder forward, and accumulates the molten resin on the front side of the internal space of a second cylinder. Then, the injection molding machine injects the molten resin accumulated in front of a second cylinder to a mold device by moving a second injection member (a second plunger) forward.

### SUMMARY

According to one aspect of the present disclosure, an injection molding machine includes a cylinder; an injection member housed within the cylinder; and a molten resin supply device connected to the cylinder and configured to pump a molten resin from a position closer to a proximal end of the injection member than to a distal end of the injection member, wherein in the cylinder, a pumping force applied to the molten resin by the molten resin supply device is used to move the molten resin in front of the injection member, and the molten resin is accumulated on a front side of an internal space of the cylinder, and the molten resin is injected from the distal end of the cylinder by moving the injection member forward.

### BRIEF DESCRIPTION OF THE DRAWINGS

FIG. 1 is a side view illustrating an overall configuration of an injection molding machine system according to a first embodiment;

FIG. 2 is a cross-sectional view schematically illustrating an injection device of an injection molding machine according to the first embodiment;

FIG. 3A is a side view of a first injection member according to the first embodiment;

FIG. 3B is a side view of a first injection member according to a first modification;

FIG. 3C is a side view of a first injection member according to a second modification;

FIG. 4 is a flowchart illustrating the operation of the injection device of the injection molding machine;

FIG. 5A is a cross-sectional view illustrating the operation of a reservoir cylinder in a reservoir storage process and the operation of an injection cylinder in an injection process;

FIG. 5B is a cross-sectional view illustrating the operation of the injection cylinder in a metering process; and

FIG. 6 is a cross-sectional view schematically illustrating an injection device of an injection molding machine according to a second embodiment.

### DETAILED DESCRIPTION

A generally known injection molding machine supplies a solid resin, serving as a molding material, to the proximal end of a cylinder, and applies pressure and friction to the solid resin by rotating a screw inside the cylinder while applying heat from the outside of the cylinder, thereby melting the solid resin. Conversely, in the related-art injection molding machine, a resin that is a molding material is melted before being supplied into the first cylinder, and the molten resin is supplied into the first cylinder.

In the related-art injection molding machine, if a screw is adopted as the first injection member, the molten resin, supplied to the proximal end of the first cylinder, can be conveyed by the rotation of the screw in the first cylinder. However, in this case, excessive stress is applied to the molten resin supplied into the first cylinder due to the rotation of the screw, and there is a high possibility that the molten resin deteriorates.

It is an object of one embodiment of the present disclosure to provide an injection molding machine that can inject a molten resin with less deterioration.

According to one aspect of the present disclosure, an injection molding machine can inject a molten resin with less deterioration by a simple configuration.

Hereinafter, embodiments of the present disclosure will be described with reference to the drawings. In the drawings, the same components are denoted by the same reference numerals, and a duplicate description thereof may be omitted.

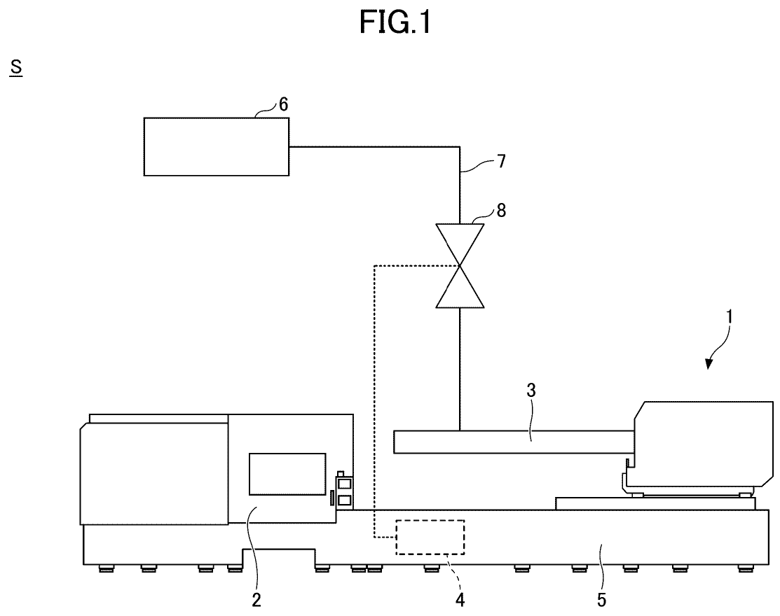

FIG. 1 is a side view illustrating an overall configuration of an injection molding machine system S according to a first embodiment. As illustrated in FIG. 1, the injection molding machine system S according to the first embodiment includes an injection molding machine 1, a molten resin supply device 6, a molten resin supply path 7, and a control valve 8.

The injection molding machine 1 includes a mold clamping device 2 that opens and closes a mold device (not illustrated), and an injection device 3 that injects a molding material into a cavity space of the mold device. In addition, the injection molding machine 1 includes an ejector device (not illustrated) that ejects a molded product molded by the mold device, a moving device (not illustrated) that moves the injection device 3 forward and backward with respect to the mold device, and a frame 5 that supports components of the injection molding machine 1. The injection molding machine 1 further includes a controller 4 that controls each of the components of the injection molding machine 1.

The mold clamping device 2 sequentially performs, based on a control command of the controller 4, a mold closing process of causing a movable mold to touch a stationary mold, a pressure increasing process of increasing a mold clamping force, a mold clamping process of maintaining the mold clamping force, a pressure releasing process of reducing the mold clamping force, a mold opening process of separating the movable mold from the stationary mold, and the like.

The injection device 3 performs a metering process, a filling process, a pressure-holding process, and the like based on a control command of the controller 4. The filling process and the pressure-holding process are hereinafter also collectively referred to as an “injection process”. The operation of the injection device 3 will be described in detail later.

The ejector device performs, based on a control command of the controller 4, an ejection process of moving an ejector rod (not illustrated) forward from a standby position to an ejection position, ejecting a molded product, and subsequently retracting the ejector rod to the original standby position.

The moving device moves the injection device 3 forward and backward relative to the mold device. By moving the injection device 3 forward toward the mold device, the injection device 3 is pressed against the stationary mold of the mold device. By moving the injection device 3 backward, the injection device 3 is separated from the stationary mold of the mold device.

The controller 4 repeatedly performs the metering process, the mold closing process, the pressure increasing process, the mold clamping process, the filling process, the pressure-holding process, a cooling process, the pressure releasing process, the mold opening process, the ejection process, and the like, thereby repeatedly manufacturing a molded product. A series of operations for obtaining a molded product, for example, a series of operations from the start of the metering process to the start of the next metering process is also referred to as a “molding cycle”. The time required for one molding cycle is referred to as a “molding cycle time”.

One molding cycle includes, for example, the metering process, the mold closing process, the pressure increasing process, the mold clamping process, the filling process, the pressure-holding process, the cooling process, the pressure releasing process, the mold opening process, and the ejection process, which are performed in this order. The order above is the order of starting each of the processes. The filling process, the pressure-holding process, and the cooling process are performed during the mold clamping process. The start of the mold clamping process may coincide with the start of the filling process. The end of the pressure releasing process coincides with the start of the mold opening process.

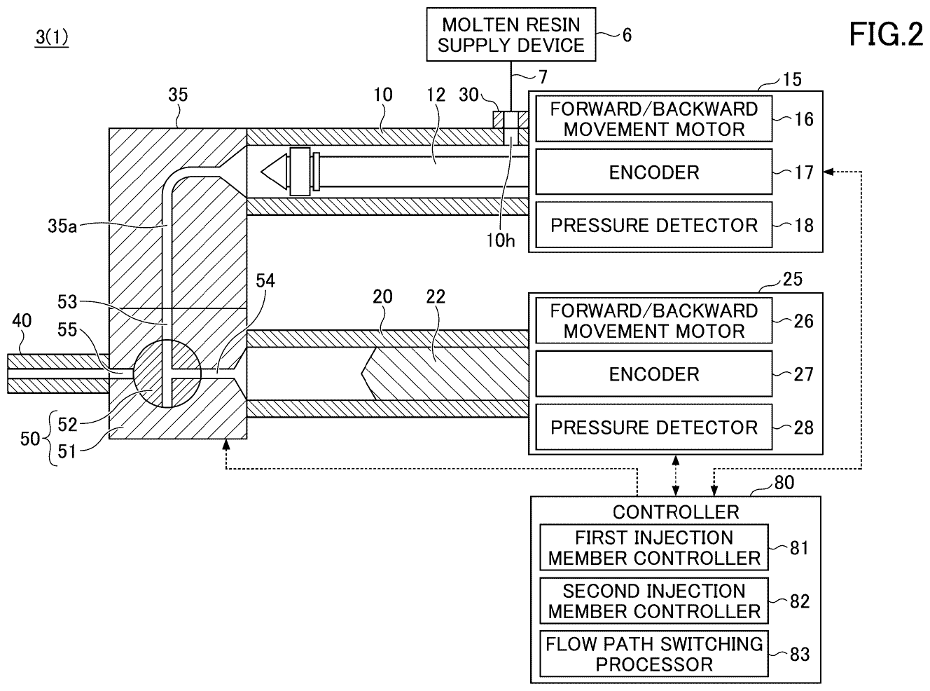

Multiple processes may be performed simultaneously in order to shorten the molding cycle time. For example, the metering process may be performed during the cooling process in the previous molding cycle. In this case, the mold closing process may be performed at the beginning of the molding cycle. Further, the filling process may be started during the mold closing process. Further, the ejection process may be started during the mold opening process. In a case where a direction switching valve 50 (see FIG. 2) is provided in the injection device 3, the mold opening process may be started during the metering process. This is because, even if the mold opening process is started during the metering process, a molding material does not leak from a nozzle 40 of the injection device 3 as long as the direction switching valve 50 closes a flow path of the injection device 3.

Further, one molding cycle may include processes other than the metering process, the mold closing process, the pressure increasing process, the mold clamping process, the filling process, the pressure-holding process, the cooling process, the pressure releasing process, the mold opening process, and the ejection process.

The molten resin supply device 6 supplies a molten resin (a liquid molding material), which is a molten molding material (resin), to the injection device 3. Specifically, the molten resin supply device 6 melts a solid recycled resin (for example, a pelletized resin containing polyethylene terephthalate (PET)) while stirring the resin, and supplies the resin to the molten resin supply path 7 on the downstream side. The molten resin supply device 6 functions as a pumping device configured to continuously supply a molten resin to the molten resin supply path 7 so as to apply a pumping force to the supplied molten resin, and pump the molten resin by using the pumping force applied to the molten resin by the molten resin supply device 6. As used herein, the expression “pumping the molten resin by using the pumping force applied to the molten resin by the molten resin supply device 6” refers to pumping the molten resin by applying pressure to the molten resin to the extent that the molten resin supplied to the proximal end side of the injection device 3 (a reservoir cylinder 10) can be moved to the distal end of the injection device 3 in a cylinder, even in a state where, other than the pumping force applied to the molten resin by the molten resin supply device 6, a conveying member or the like that conveys the molten resin to the distal end side is not provided, or a conveying member or the like that conveys the molten resin to the distal end side is provided, but the conveying member is stopped and no force is applied to the molten resin by the conveying member.

The molten resin supply path 7 is a path through which the molten resin is supplied from the molten resin supply device 6 to the injection device 3. The molten resin supply path 7 may include, for example, a pipe through which the molten resin flows, a heat insulator that covers the pipe, a heater that keeps the molten resin flowing through the pipe warm, and the like.

The control valve 8 is provided in the molten resin supply path 7, is communicatively connected to the controller 4, and switches between supply and stop of supply of the molten resin to the injection device 3. As the control valve 8, for example, an on-off valve can be applied.

FIG. 1 illustrates a configuration in which one injection molding machine 1 is connected to the molten resin supply path 7; however, the injection molding machine system S is not limited to this configuration and may have a configuration in which a plurality of injection molding machines 1 are connected to the molten resin supply path 7. Further, FIG. 1 illustrates a configuration in which one molten resin supply device 6 is connected to the molten resin supply path 7; however, the injection molding machine system S is not limited this configuration and may have a configuration in which a plurality of molten resin supply devices 6 are connected to the molten resin supply path 7.

### <Configuration of Injection Device 3 According to First Embodiment>

Next, the injection device 3 of the injection molding machine 1 will be described with reference to FIG. 2. FIG. 2 is a cross-sectional view schematically illustrating the injection device 3 of the injection molding machine 1 according to the embodiment.

The injection device 3 of the injection molding machine 1 injects a molten resin, which is a molding material, into the above-described mold device by using two cylinders. Specifically, the injection device 3 includes the reservoir cylinder (a first cylinder), a first injection member 12, an injection cylinder 20 (a second cylinder), and a second injection member 22 (a second-cylinder-side injection member). Further, the injection device 3 includes a first injection member driver 15 that operates the first injection member 12 and a second injection member driver 25 that operates the second injection member 22. Further, the injection device 3 includes a supply connector 30, a connection part 35, the nozzle 40, the direction switching valve 50, and a controller 80.

The reservoir cylinder 10 is formed in a cylindrical shape extending in the horizontal direction. The connection part 35 is coupled to the distal end of the reservoir cylinder 10, and the first injection member driver 15 is installed at the proximal end of the reservoir cylinder 10. The reservoir cylinder 10 has a hole 10h at a position closer to the proximal end of the first injection member 12 than to the distal end of the first injection member 12, and a molten resin is introduced into an internal space through the hole 10h. The supply connector 30, which is a connector communicating with the hole 10h and connected to the molten resin supply path 7, is provided on the outer peripheral surface of the reservoir cylinder 10. A heating device (not illustrated) that keeps the temperature of or heats the molten resin supplied into the internal space may be installed in the cylindrical wall constituting the reservoir cylinder 10.

As described above, the molten resin supply device 6 has a function to pump the molten resin toward the molten resin supply path 7 on the downstream side. Therefore, the injection device 3 pumps the molten resin from the molten resin supply device 6 into the internal space of the reservoir cylinder 10 through the molten resin supply path 7, the supply connector 30, and the hole 10h. The molten resin supplied into the internal space of the reservoir cylinder 10 flows toward the front of the reservoir cylinder 10 by receiving the pumping force to pump the molten resin continuously supplied from the upstream side (through the molten resin supply path 7). In other words, the molten resin supplied from the external molten resin supply device 6 into the reservoir cylinder 10 is moved by the pumping force and is accumulated on the front side of the internal space of the reservoir cylinder 10

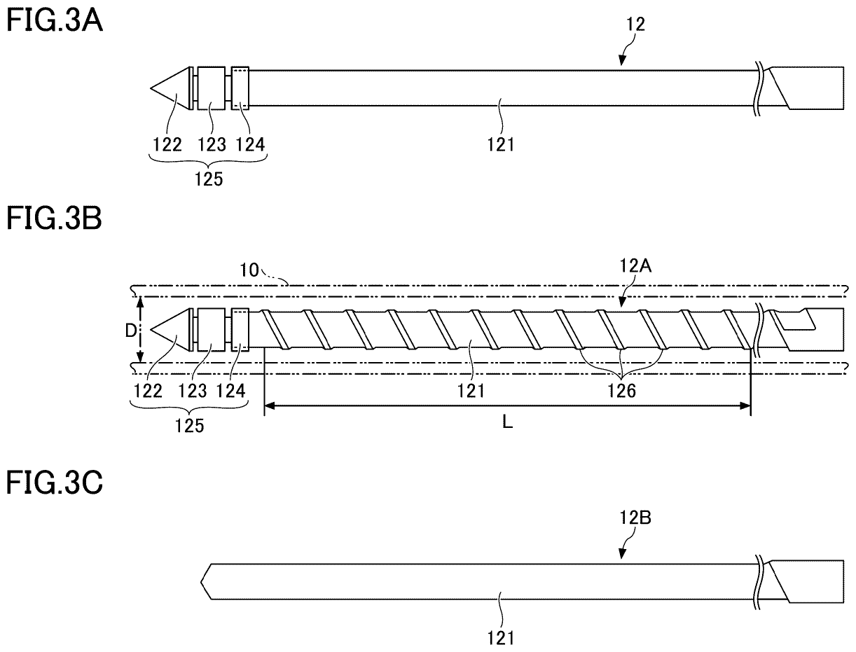

FIG. 3A is a side view of the first injection member 12 according to the first embodiment. FIG. 3B is a side view of a first injection member 12A according to a first modification. FIG. 3C is a side view of a first injection member 12B according to a second modification. As illustrated in FIG. 3A, the first injection member 12 is formed as a solid rod member, and is configured as a screw provided so as to be movable forward and backward within the internal space of the reservoir cylinder 10. The axial center of the first injection member 12 is located coaxially with the axial center of the reservoir cylinder 10.

The first injection member 12 according to the embodiment includes a shaft body 121 extending in the axial direction of the reservoir cylinder 10. The shaft body 121 does not include a helical flight on the outer peripheral surface, and is configured not to rotate around the axis. As described above, the molten resin in the reservoir cylinder 10 can be moved forward within the internal space by the pumping force applied from the molten resin supply device 6. Thus, unlike a first injection member provided with a flight, the molten resin can be accumulated on the front side of the internal space without causing the first injection member 12 to rotate around the axis. Note that the first injection member 12 may be configured to rotate around the axis in order to suppress adhesion or accumulation of the molten resin at a specific portion of the outer peripheral surface.

The outer peripheral surface of the shaft body 121 of the first injection member 12 is a smooth curved surface without irregularities. The outer diameter of the shaft body 121 is set to be smaller than the outer diameter of the second injection member 22, which will be described later. A constant gap is formed between the shaft body 121 and the cylindrical wall of the reservoir cylinder over the entire circumference in the circumferential direction. For example, the outer diameter of the shaft body 121 may be set in a range of approximately ½ to 9/10 of the inner diameter of the reservoir cylinder 10.

Further, a backflow prevention assembly 125 in which a screw head 122, a backflow prevention ring 123, a seal ring 124, and the like are combined is provided at the distal end of the first injection member 12. While the backflow prevention assembly 125 allows the molten resin to move toward the distal end of the first injection member 12, the backflow prevention assembly 125 restricts the molten resin accumulated on the front side of the internal space from flowing backward when the first injection member 12 is moved forward.

The first injection member 12 is moved forward and backward (slides) relative to the reservoir cylinder 10 by the first injection member driver 15. For example, when a reservoir storage process of supplying a molten resin into the internal space of the reservoir cylinder 10 is performed, the first injection member 12 is moved backward in accordance with the storage amount (pressure) of the molten resin stored in front of the first injection member 12. As a result, the reservoir cylinder 10 stores the target storage amount of the molten resin in the internal space in front of the first injection member 12. Then, by moving the first injection member 12 forward after the reservoir storage process, the molding material in the internal space of the reservoir cylinder 10 is pushed out from the distal end of the reservoir cylinder 10.

The first injection member driver 15 closes the proximal end of the reservoir cylinder 10 and holds the proximal end of the first injection member 12. For example, the first injection member driver 15 includes a forward/backward movement motor 16, an encoder 17, and a pressure detector 18.

The forward/backward movement motor 16 moves the first injection member 12 forward and backward along the axial center of the reservoir cylinder 10. A motion conversion mechanism that converts the rotational motion of the forward/backward movement motor 16 into the linear motion of the first injection member 12 is provided between the first injection member 12 and the forward/backward movement motor 16. For example, a ball screw can be applied as the motion conversion mechanism.

The encoder 17 detects the rotation of the forward/backward movement motor 16 and transmits a detection signal thereof to the controller 80. The controller 80 calculates the position and the moving speed of the first injection member 12 based on the detection signal of the encoder 17, and controls the operation of the first injection member 12 by using the calculation results.

The pressure detector 18 is provided in a transmission path between the forward/backward movement motor 16 and the first injection member 12, detects a force transmitted between the forward/backward movement motor 16 and the first injection member 12, and transmits a detection signal thereof to the controller 80. The controller 80 calculates the pressure of the first injection member 12 based on the detected force, and adjusts or monitors the pressure received by the first injection member 12 from the molding material (back pressure against the first injection member 12), the pressure acting on the molding material from the first injection member 12, and the like. The pressure applied to the first injection member 12 corresponds to the pressure received by the screw head 122 and the backflow prevention ring 123 from the molding material on the distal end side of the first injection member 12. Since there is a gap between the screw head 122 and the inner diameter of the reservoir cylinder 10, a portion of the molding material flows backward through the gap. This increases the pressure applied to the backflow prevention ring 123.

The injection cylinder 20 is formed in a cylindrical shape extending in parallel to the reservoir cylinder 10 (in the horizontal direction). The direction switching valve 50 is coupled to the distal end of the injection cylinder 20, and the second injection member driver 25 is installed at the proximal end of the injection cylinder 20. The molten resin is supplied into the internal space of the injection cylinder 20 from the distal end side via the direction switching valve 50. A heating device (not illustrated) that keeps warm or heats the molten resin supplied into the internal space may be installed in the cylindrical wall constituting the injection cylinder 20.

The second injection member 22 is formed as a solid rod member, and is configured as a plunger provided so as to be movable within the internal space of the injection cylinder 20. The axial center of the second injection member 22 is located coaxially with the axial center of the injection cylinder 20. The outer peripheral surface of the second injection member 22 is a smooth curved surface, and the outer diameter of the second injection member 22 is set to be the same as or slightly smaller than the inner diameter of the injection cylinder 20. Accordingly, the second injection member 22 can be moved forward and backward (slide) relative to the injection cylinder 20. The forward/backward movement of the second injection member 22 moves the molding material supplied into the internal space of the injection cylinder 20.

The second injection member driver 25 closes the proximal end of the injection cylinder 20 and holds the proximal end of the second injection member 22. Similar to the first injection member driver 15, the second injection member driver 25 also includes a forward/backward movement motor 26, an encoder 27, and a pressure detector 28.

The forward/backward movement motor 26 moves the second injection member 22 forward and backward along the axial center of the injection cylinder 20. A motion conversion mechanism that converts the rotational motion of the forward/backward movement motor 26 into the linear motion of the second injection member 22 is provided between the second injection member 22 and the forward/backward movement motor 26. For example, a ball screw can be applied as the motion conversion mechanism.

The encoder 27 detects the rotation of the forward/backward movement motor 26 and transmits a detection signal thereof to the controller 80. The controller 80 calculates the position and the moving speed of the second injection member 22 based on the detection signal of the encoder 27, and controls the operation of the second injection member 22 by using the calculation results.

The pressure detector 28 is provided in a transmission path between the forward/backward movement motor 26 and the second injection member 22, detects a force transmitted between the forward/backward movement motor 26 and the second injection member 22, and transmits a detection signal thereof to the controller 80. The controller 80 calculates the pressure of the second injection member 22 based on the detected force, and adjusts or monitors the pressure received by the second injection member 22 from the molding material (back pressure against the second injection member 22), the pressure acting on the molding material from the second injection member 22, and the like.

The connection part 35 is a member that connects the reservoir cylinder 10 and the direction switching valve 50, and allows the molten resin to flow through a flow path 35a inside the connection part 35. The flow path 35a of the connection part is curved at 90° in the block such that the molten resin in the reservoir cylinder 10 can smoothly flow toward the direction switching valve 50.

The nozzle 40 is disposed on the opposite side of the direction switching valve 50 from the injection cylinder 20, and is formed in a cylindrical body communicating with a flow path (such as a runner) of the mold device. The nozzle allows the molten resin pushed out from the injection cylinder 20 to flow through the direction switching valve 50 and injects the molten resin into the mold device. The mold device molds a molded product through solidification of the molten resin filled into the cavity space of the mold device from the nozzle 40.

The direction switching valve 50 is provided between the connection part 35, the injection cylinder 20, and the nozzle 40, and switches the flow of the molten resin. The direction switching valve 50 includes a valve box 51, a valve body 52, and a valve body driver (not illustrated).

The valve box 51 is formed in a substantially rectangular parallelepiped shape and houses the valve body 52. The valve box 51 has a supply-side connection port 53 communicating with the flow path of the connection part 35, an injection cylinder connection port 54 communicating with the internal space of the injection cylinder 20, and a nozzle connection port 55 communicating with the inside of the nozzle 40. The injection cylinder connection port 54 and the nozzle connection port 55 are provided on the opposing surfaces of the valve body 52 with the rotation center line of the valve body 52 interposed therebetween, for example. The supply-side connection port 53 is provided on the surface of the valve body 52 so as to extend in a direction orthogonal to an axis line connecting the injection cylinder connection port 54 and the nozzle connection port 55, for example.

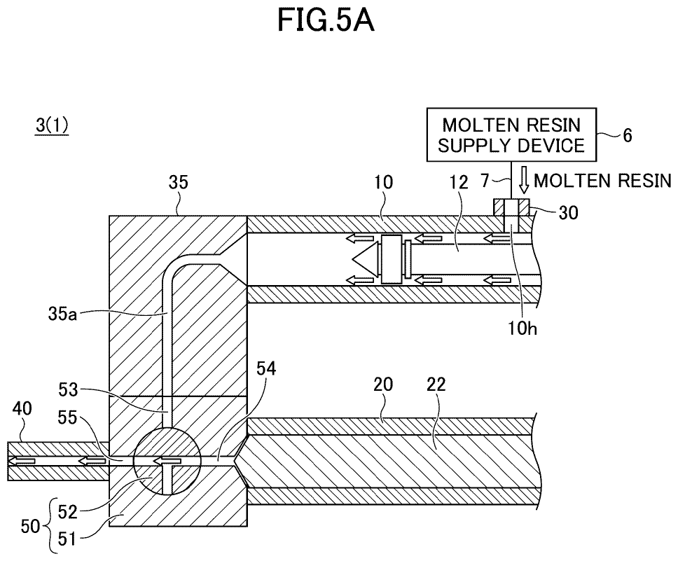

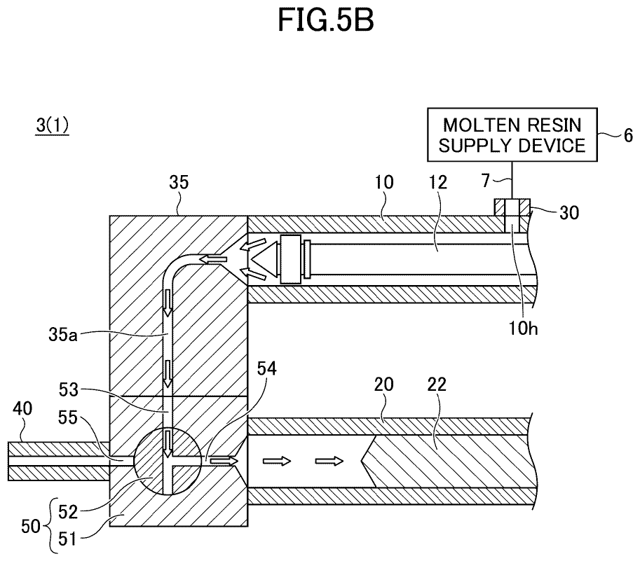

The valve body 52 rotates within the valve box 51, thereby switching the direction switching valve 50 between a first state and a second state. In the first state, the valve body 52 allows the supply-side connection port 53 and the injection cylinder connection port 54 to communicate with each other, and closes the nozzle connection port 55. In the second state, the valve body 52 allows the injection cylinder connection port 54 and the nozzle connection port 55 to communicate with each other, and closes the supply-side connection port 53 (see also FIG. 5A). Thus, in the first state, the molten resin can be moved from the connection part 35 toward the injection cylinder 20. In the second state, the molten resin can be moved from the injection cylinder 20 to the nozzle 40.

The valve body driver switches between the first state and the second state described above by rotating the valve body 52 within the valve box 51. The states of the valve body 52 are not limited to the first state and the second state. For example, the valve body 52 can be in a state of simultaneously closing the supply-side connection port 53, the injection cylinder connection port 54, and the nozzle connection port 55. Further, the valve body 52 can be in a state of blocking the injection cylinder connection port 54 while allowing the supply-side connection port 53 and the nozzle connection port 55 to communicate with each other.

The functions of the controller 80 may be implemented by any hardware, software, or a combination of hardware and software. For example, the controller 80 may be a computer including a processor, a memory, an input/output interface, and a communication interface, which are not illustrated. The processor is one of or a combination of two or more of a central processing unit (CPU), a graphics processing unit (GPU), an application specific integrated circuit (ASIC), a field-programmable gate array (FPGA), a circuit including a plurality of discrete semiconductors, and the like, and executes a program stored in the memory. The memory includes a main storage device consisting of a semiconductor memory or the like, and an auxiliary storage device consisting of a disk, a semiconductor memory (flash memory), or the like.

The controller 80 controls the operations of components (the first injection member driver 15, the second injection member driver 25, the direction switching valve 50, and the like) of the injection device 3 based on various commands of the controller 4 that controls the entire injection molding machine system S. The injection molding machine system S may have a configuration in which the controller 4 also serves as the controller 80 of the injection device 3 (in other words, directly controls the injection device 3).

The controller 80 configures a first injection member controller 81, a second injection member controller 82, and a flow path switching processor 83 therein by the processor reading and executing the program in the memory. The first injection member controller 81 controls the operation of the first injection member 12. The second injection member controller 82 controls the operation of the second injection member 22. The flow path switching processor 83 controls each state of the direction switching valve 50 to switch the flow direction of the molten resin.

### <Operation of Injection Device 3>

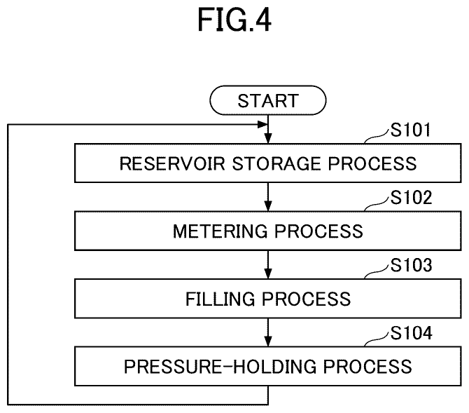

Next, the operation of the injection device 3 of the injection molding machine 1 will be described with reference to FIG. 4. FIG. 4 is a flowchart illustrating the operation of the injection device 3 of the injection molding machine 1. The injection device 3 sequentially performs the reservoir storage process (step S101), the metering process (step S102), the filling process (step S103), and the pressure-holding process (step S104) illustrated in FIG. 4 as controlled by the controller 80, and repeats these processes.

In the reservoir storage process, the injection device 3 accumulates a predetermined amount of a molten resin on the front side of the internal space of the reservoir cylinder 10. Then, in the metering process, the injection device 3 accumulates the predetermined amount of the molten resin on the front side of the internal space of the injection cylinder 20 by moving the first injection member 12 of the reservoir cylinder 10 forward and discharging the molten resin from the reservoir cylinder 10. In the filling process, the injection device 3 fills the cavity space of the mold device with the molten resin, accumulated in the injection cylinder 20, via the nozzle 40 by moving the second injection member 22 forward. In the pressure-holding process, the injection device 3 pushes out the molten resin remaining in the injection cylinder toward the mold device while maintaining the pressure (holding pressure) of the molten resin in front of the second injection member 22 at a predetermined pressure. Further, the injection molding machine 1 starts the cooling process after the pressure-holding process and solidifies the molding material within the cavity space of the mold device. For the purpose of shortening the molding cycle time, the injection molding machine 1 may perform the reservoir storage process while the injection process (the filling process and the pressure-holding process) of the immediately previous molding cycle is performed. Further, the injection molding machine 1 may perform the metering process during the cooling process.

A specific operation in each of the processes will be described below with reference to FIG. 5A and FIG. 5B. FIG. 5A is a cross-sectional view illustrating the operation of the reservoir cylinder 10 in the reservoir storage process and the operation of the injection cylinder 20 in the injection process. FIG. 5B is a cross-sectional view illustrating the operation of the injection cylinder 20 in the metering process.

In the reservoir storage process, the flow path switching processor 83 of the controller 80 puts the valve body 52 of the direction switching valve 50 into the second state as illustrated in FIG. 5A. This is because, as described above, in the reservoir storage process, the injection cylinder 20 and the nozzle 40 need to be communicated with each other in order to perform the injection process (the filling process and the pressure-holding process) on the injection cylinder side.

Then, in the reservoir storage process, by pumping a molten resin from the molten resin supply device 6 through the molten resin supply path 7, the molten resin flows to the proximal end side of the internal space of the reservoir cylinder 10 via the supply connector 30. The molten resin that has flowed into the reservoir cylinder 10 is moved to the front side through the internal space (the periphery of the first injection member 12) of the reservoir cylinder 10 by receiving a pumping force applied to the molten resin by the molten resin supply device 6. The molten resin moved to the front side of the internal space of the reservoir cylinder 10 is prevented from flowing out from the reservoir cylinder 10 because the flow path of the connection part 35 is closed by the valve body 52 of the direction switching valve 50.

The first injection member 12 of the reservoir cylinder 10 is pushed by the molten resin that is moved to the front side of the internal space, and thus the first injection member 12 is moved backward relative to the reservoir cylinder 10. Alternatively, the first injection member controller 81 of the injection device 3 may control the forward/backward movement motor 16 based on the pressure of the molten resin pumped from the molten resin supply device 6, so as to move the first injection member 12 backward in the reservoir storage process. For example, the first injection member controller 81 may adjust the backward movement speed of the first injection member 12 such that the pressure of the molten resin detected by the pressure detector 18 matches a target pressure.

When the target amount of the molten resin is accumulated on the front side of the inner space of the reservoir cylinder 10 in the reservoir storage process, the controller 80 ends the reservoir storage process and starts the metering process (step S102 of FIG. 4). At this time, the flow path switching processor 83 of the controller 80 controls the valve body driver of the direction switching valve 50 to put the valve body 52 into the first state as illustrated in FIG. 5B. That is, the flow path of the connection part 35 and the internal space of the injection cylinder 20 are put into a state of communicating with each other via the direction switching valve 50, and the molten resin can be supplied from the connection part 35 to the injection cylinder 20.

Then, in the metering process, the first injection member controller 81 of the controller 80 drives the forward/backward movement motor 16 to move the first injection member 12 forward. At this time, the first injection member controller 81 calculates the position or the moving speed of the first injection member 12 based on a detection value of the encoder 17, and controls the moving speed of the first injection member 12. The first injection member 12 pushes out the molten resin in the internal space of the reservoir cylinder 10 by the backflow prevention assembly 125, and discharges the molten resin from the distal end of the reservoir cylinder 10. The molten resin pushed out from the reservoir cylinder 10 smoothly flows through the connection part 35 and flows into the internal space of the injection cylinder 20 via the direction switching valve 50. As a result, the molten resin is accumulated in front of the second injection member 22 in the internal space of the injection cylinder 20.

In the metering process, the controller 80 of the injection device 3 may cause the second injection member controller 82 to drive the forward/backward movement motor 26 so as to move the second injection member 22 backward in accordance with the forward movement of the first injection member 12. That is, when the molten resin pushed out from the reservoir cylinder 10 flows into the injection cylinder 20, the second injection member 22 is moved backward within the injection cylinder by the driving force of the forward/backward movement motor 26. Accordingly, as compared to when the molten resin presses the second injection member 22 so as to move the second injection member 22 backward, the pressure of the molten resin in the injection cylinder 20 is reduced.

After the metering process described above, the controller 80 starts the filling process (step S103). Returning to FIG. 5A, the flow path switching processor 83 of the controller 80 controls the valve body driver of the direction switching valve 50 to put the valve body 52 into the second state. That is, the internal space of the injection cylinder 20 and the flow path of the nozzle 40 are communicated with each other via the direction switching valve 50, and the flow path of the connection part 35 is blocked.

Then, in the filling process, the second injection member controller 82 of the controller 80 drives the forward/backward movement motor 26 to move the second injection member 22 forward to a predetermined position. At this time, the second injection member controller 82 calculates the position or the moving speed of the second injection member 22 based on a detection value of the encoder 27, and controls the moving speed of the second injection member 22. The second injection member 22 discharges, from the injection cylinder 20, the molten resin accumulated in front of the second injection member 22 in the internal space of the injection cylinder 20. The molten resin in the injection cylinder 20 is moved to the nozzle 40 via the direction switching valve 50, flows through the flow path of the nozzle 40, and is filled in the cavity space of the mold device.

After the filling process, the controller 80 starts the pressure-holding process (step S104). In this case, the second injection member controller 82 of the controller 80 controls the rotation of the forward/backward movement motor 26 based on a detection value of the pressure detector 28 so as to maintain the pressure (holding pressure) of the molten resin to be pushed out by the second injection member 22 at a predetermined pressure, and moves the second injection member 22 forward. The forward movement of the second injection member 22 allows the second injection member 22 to push out the molten resin remaining in the internal space of the injection cylinder 20 toward the mold device.

As described above, the injection molding machine 1 can repeatedly manufacture a molded product by causing the mold clamping device 2, the ejector device, and the moving device to work in conjunction with each other while performing the reservoir storage process, the metering process, the filling process, and the pressure-holding process in the injection device 3. The injection molding machine 1 can inject a molten resin with less deterioration by a simple configuration in which the molten resin is pumped from the proximal end side of the reservoir cylinder 10 and is accumulated in the reservoir cylinder 10. That is, a molten resin in the reservoir cylinder 10 flows in one direction, and stagnation of the molten resin can be suppressed. Thus, deterioration of the molten resin due to stagnation can be avoided. As a result, the quality of the molten resin to be injected is improved, and the quality of a molded product can be improved.

Further, the first injection member 12 includes the backflow prevention assembly 125 (the screw head 122, the backflow prevention ring 123, and the seal ring 124), and thus, when the first injection member 12 is moved forward, backflow of a molten resin can be prevented. Therefore, the first injection member 12 can accurately discharge the molten resin to the injection cylinder 20. In addition, the injection molding machine 1 does not need to include a valve or the like for preventing backflow.

Further, the first injection member 12 includes the shaft body 121 having a curved surface without irregularities, and thus the necessity of kneading or the like of a molten resin can be eliminated, and an influence on the molten resin due to kneading or the like can be suppressed. Further, because no flight is included, the structure of the first injection member 12 is simplified, and thus the manufacturing cost can be reduced. In particular, a recycled resin is easily deteriorated, and thus, by pumping a molten resin so as to eliminate shearing by a flight while suppressing stagnation, deterioration of the recycled resin can be significantly suppressed. A molding material to be injected by the injection molding machine 1 is not limited to the recycled resin, and various materials may be applied. Even in such a case, the first injection member 12 can suppress deterioration due to the conveyance load of the screw. However, by applying the first injection member 12 to the injection device 3 that conveys a molten resin instead of a solid resin, a large effect of suppressing deterioration of the molten resin can be obtained.

The injection molding machine 1 according to the present disclosure is not limited to the above-described embodiment, and various modifications are possible. For example, in the injection molding machine 1, the first injection member 12 of the reservoir cylinder 10 is not limited to the screw without a flight as described above, and various structures may be applied. Hereinafter, some other configurations of the first injection member 12 will be described with reference to FIG. 3B and FIG. 3C.

As illustrated in FIG. 3B, the first injection member 12A according to the first modification differs from the above-described first injection member 12 in that the first injection member 12A includes a helical flight 126 formed on the outer peripheral surface of the shaft body 121 so as to slightly protrude from the outer peripheral surface of the shaft body 121. That is, in the above-described embodiment, a molten resin is pumped by the molten resin supply device 6, and thus no flight is included. However, the flight 126 that can assist the conveyance of the molten resin while suppressing deterioration of the molten resin may be included. In this case, the first injection member 12A is configured to rotate around the axis in the reservoir cylinder 10.

The flight 126 of the first injection member 12 is appropriately designed, for example, to have a small outer diameter (low height), a wide pitch, a small number of blades or a small ratio of blades, as compared to a flight of a typical screw that moves a molding material while melting and kneading the molding material. FIG. 3B illustrates an example in which the flight 126 has a small outer diameter. For example, the outer diameter of the flight 126 is set to be smaller than the outer diameter of the backflow prevention ring 123.

Further, when the flight 126 is provided, a length L of a portion where the flight 126 is provided is preferably smaller than the entire length of the screw. For example, when D denotes the inner diameter of the reservoir cylinder 10 and L denotes the length of the flight 126, the length L of the flight 126 is preferably set such that L/D 15. By decreasing the length L of the flight 126 in the shaft body 121, a range of the shaft body 121 in which the flight 126 affects a molten resin can be reduced, and as a result, deterioration of the molten resin can be suppressed. Further, the first injection member 12 including the flight 126 can smoothly move the molten resin, which is pumped into the reservoir cylinder 10, to the front side of the reservoir cylinder 10. It is preferable that the length L of the flight 126 is not too long with respect to the inner diameter D of the reservoir cylinder 10 regardless of the outer diameter of the flight 126. Specifically, it is preferable that the length L of the flight 126 is not too long with respect to the inner diameter D of the reservoir cylinder 10 even when the outer diameter of the flight 126 is substantially equal to the inner diameter D of the reservoir cylinder 10 or is less than the inner diameter D of the reservoir cylinder (for example, is equal to or less than half the distance between the shaft body 121 and the inner peripheral surface of the reservoir cylinder 10). However, even when a flight has a helical protrusion, if the helical protrusion has a height of only 5% or less of the distance between the shaft body 121 and the inner peripheral surface of the reservoir cylinder 10 and does not promote deterioration of a molten resin, such a flight is not considered as a flight as referred to herein.

As illustrated in FIG. 3C, the first injection member 12B according to the second modification differs from the first injection members 12 and 12A described above in that no backflow prevention assembly 125 is provided at the distal end of a shaft body 121. As described above, a molten resin is continuously pumped through the molten resin supply path 7 into the reservoir cylinder 10. Therefore, even if the first injection member 12B including no backflow prevention assembly 125 is used and the first injection member 12B is pushed after the reservoir storage process, backflow of the molten resin to the proximal end side can be suppressed, and the molten resin can be discharged from the distal end of the reservoir cylinder 10.

<Configuration and Operation of Injection device 3A According to Second Embodiment>

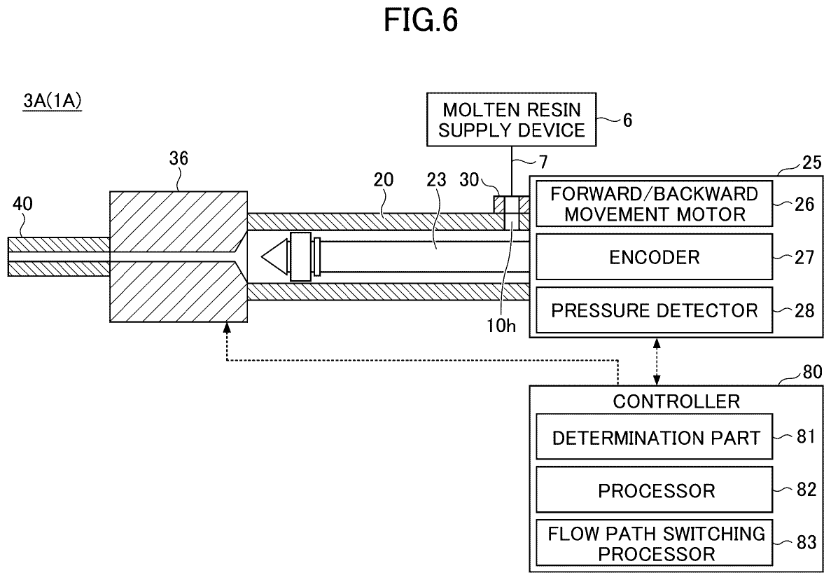

FIG. 6 is a cross-sectional view schematically illustrating an injection device 3A of an injection molding machine 1A according to a second embodiment. The injection molding machine 1A according to the second embodiment differs from the injection molding machine 1 according to the first embodiment, in that the injection molding machine 1A includes one injection cylinder 20 and one injection member 23. A molten resin is pumped into the injection cylinder from a position closer to the proximal end than to the distal end of the injection member 23. As described, even when one injection cylinder 20 is applied, the injection molding machine 1A can satisfactorily accumulate the molten resin on the front side of the internal space of the injection cylinder 20 (in front of the injection member 23) by pumping the molten resin from the proximal end side of the injection cylinder 20.

A valve body is not provided at the distal end of the injection cylinder 20, and a connection part 36 for connecting to a nozzle 40 is provided at the distal end of the injection cylinder 20. Further, the injection member 23 can be configured in a similar manner to one of the first injection members 12, 12A, and 12B according to the first embodiment, the first modification, and the second modification. For example, FIG. 6 illustrates a configuration in which a shaft body 121 does not include a flight and includes a backflow prevention assembly 125.

In the injection molding machine 1A, in a metering process of accumulating a molten resin in the injection cylinder 20, the molten resin that is pumped is moved forward within the injection cylinder 20, similar to the above-described reservoir storage process. Then, in an injection process (a filling process and a pressure-holding process), the injection molding machine 1A can inject the molten resin accumulated on the front side to a mold device by moving the injection member 23 forward.

The injection molding machines 1 and 1A according to the embodiments disclosed herein are exemplary in all respects and not restrictive. The embodiments can be modified and improved in various forms without departing from the scope and spirit of the appended claims. The matters described in the plurality of embodiments can have other configurations to the extent that the matters are consistent and can be combined to the extent that the matters are consistent.

What is claimed is:

1. An injection molding machine comprising:
a cylinder;
an injection member housed within the cylinder; and
a molten resin supply device connected to the cylinder and configured to pump a molten resin from a position closer to a proximal end of the injection member than to a distal end of the injection member, wherein
in the cylinder, a pumping force applied to the molten resin by the molten resin supply device is used to move the molten resin in front of the injection member, and the molten resin is accumulated on a front side of an internal space of the cylinder, and
the molten resin is injected from a distal end of the cylinder by moving the injection member forward.

2. The injection molding machine according to claim 1, wherein the cylinder includes a first cylinder to which the molten resin is supplied from the molten resin supply device, and a second cylinder to which the molten resin is supplied from the first cylinder and configured to inject the molten resin to a mold device.

3. The injection molding machine according to claim 2, wherein
the first cylinder includes the injection member therein,
the second cylinder includes a second-cylinder-side injection member configured to be moved backward in response to the molten resin supplied from the first cylinder flowing into the second cylinder from a distal end of the second cylinder, and
the molten resin is injected from the distal end of the second cylinder to the mold device by moving the second-cylinder-side injection member forward.

4. The injection molding machine according to claim 3, further comprising:
a controller configured to control the injection member and the second-cylinder-side injection member, wherein
the controller is configured to control
a reservoir storage process of accumulating the molten resin on a front side of an internal space of the first cylinder by pumping the molten resin in the internal space of the first cylinder,
after the reservoir storage process, a metering process of accumulating the molten resin on a front side of an internal space of the second cylinder by moving the injection member forward and discharging the molten resin from the first cylinder, and
after the metering process, an injection process of injecting the molten resin from the second cylinder to the mold device by moving the second-cylinder-side injection member forward, and
the reservoir storage process is performed while the injection process is performed.

5. The injection molding machine according to claim 1, wherein the injection member includes, at the distal end thereof, a backflow prevention assembly configured to push out the molten resin present in front of the injection member and prevent backflow of the molten resin to the proximal end of the injection member.

6. The injection molding machine according to claim 1, wherein
the injection member includes a shaft body extending in an axial direction of the cylinder, and
an outer peripheral surface of the shaft body is a curved surface without irregularities.

7. The injection molding machine according to claim 1, wherein
the injection member includes a shaft body extending in an axial direction of the cylinder, and
a helical flight is formed so as to protrude from an outer peripheral surface of the shaft body.

8. The injection molding machine according to claim 1, wherein the molten resin supply device is configured to melt a recycled resin and supply the recycled resin into the cylinder.
